(19) United States
(12) Patent Application Publication
(10) Pub. No.: US 2026/0251165 A1
(43) Pub. Date: Aug. 27, 2026

(54) Clip

(71) Applicant: Illinois Tool Works Inc., Glenview, IL (US)

(72) Inventors: Ismael Fuentes Domingo, Sabadell (ES); Alexis Cañado, Sabadell (ES)

(21) Appl. No.: 19/551,969

(22) Filed: Feb. 27, 2026

(30) Foreign Application Priority Data
Feb. 27, 2025 (EP) 25160560.6
Feb. 10, 2026 (DE) 102026105454.4

(51) Int. Cl. F16B 2/24

(52) U.S. Cl. CPC F16B 2/245

(57) ABSTRACT

A clip (102) suitable for attaching a panel to a substrate. The clip includes a substantially U-shaped body (104) having a first arm (106) and a second arm (108). The first arm and the second arm are in opposition with one another. Fingers (110) are attached to the substantially U-shaped body. The one or more fingers interweave with each other.

### RELATED APPLICATIONS

The present application claims the benefit of European Patent Application No. EP 25160560.6, filed Feb. 27, 2025, and German Patent Application No. 102026105454.4, filed Feb. 10, 2026, each titled “Clip,” the contents of which are hereby incorporated by reference.

### BACKGROUND

The disclosure relates to a clip suitable for attaching a panel to a substrate. Clips are used to connect various components together, such as a panel to a frame in a vehicle. Clips can sometimes become entangled with one another when on a production line. This inhibits either a production operative from speedily carrying out their manufacturing task (as they have to detangle clips) or can block auto-feeding machines causing increased cost and delay.

### SUMMARY

The present disclosure relates generally to a clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a perspective view of a clip.

FIG. 2 illustrates a front view of the clip.

FIG. 3 illustrates a top view of the clip.

FIG. 4 illustrates a side view of the clip.

FIGS. 5A through 5D illustrates views of an alternative clip.

FIGS. 6A through 6D illustrates views of an alternative clip.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centerline or a geometric center of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

According to the disclosure there is provided a clip, suitable for attaching a panel to a substrate, the clip comprising: a substantially U-shaped body comprising a first arm and a second arm, wherein the first arm and the second arm are in opposition with one another; and fingers attached to the substantially U-shaped body; wherein the one or more fingers interweave with each other. By interweaving the fingers entanglement of a first clip with a second clip is prevented as there is no space for the fingers of the first clip to entangle with the fingers of the second clip.

Suitably, two or more of the fingers are linked via a bridge. Bridging fingers further removes opportunity for entanglement. Optionally the bridge links the two or more fingers between finger tips of the two or more fingers. Bridging also serves to provide communication between fingers, such that as a first finger of a set of bridged fingers moves, others in the set also begin to move due to the bridge connection with the first finger. This can assist in use of the clip.

Preferably, the fingers may comprise at least one knuckle to provide an inflexion point at which the finger can change direction. Suitably, the fingers interweave with each other about the at least one knuckle to increase a surface area at which the fingers are interwoven, thereby minimizing the risk of entanglement.

Suitably, at least one of the fingers is curved such that a finger tip of the at least one finger, points towards either the first arm or the second arm (optionally the arm to which that finger is attached to). Ensuring the finger tips point towards the U-shaped body reduces snagging of third party items upon the finger.

Appositely, the clip is formed by stamping, preferably in a single manufacturing step.

Preferably, the substantially U-shaped body comprises at least one aperture, and further optionally wherein the at least one aperture is located on a base of the U-shaped body. The aperture may provide a connection point for a tool to assist in manipulation of the clip or for a lock to pass through and secure the clip in place.

Suitably, one or more of the fingers are attached to the first arm or the second arm. The fingers may be attached towards an end of the arm remote from a bowl of the U-shaped body or an end of the arm proximal to a bowl of the U-shaped body. Indeed, the finger may be attached to the arm at any suitable position along the length of the body. The finger may, alternatively, be connected directly to the bowl of the U-shaped body (and either partially connected, or disconnected, to the arm). For the avoidance of doubt, “arm” here refers to either or both of the first arm and/or second arm.

Preferably, the first arm and the second arm may each comprise one or more of the fingers.

Appositely, the one or more fingers may reach into an interior of the substantially U-shaped body in order to reduce the risk of entanglement as engaging features of the clip are retained within an interior of the U-shaped body.

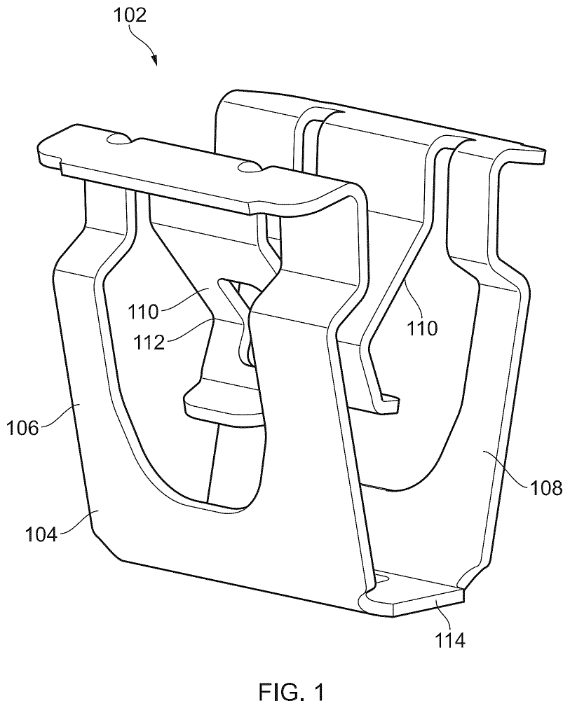

The clip 102 shown in FIG. 1 is suitable for attaching a panel to a substrate, such as a trim panel to a body in white of a vehicle. The clip 102 comprises a substantially U-shaped body 104 which has a first arm 106 and a second arm 108 forming the upright strokes (to use terminology pertaining to the anatomy of letters) of the U and attached via the swash or base of the “U”. The first arm 106 and the second arm 108 are therefore in opposition with one another, as opposed to the second arm pointing in an opposite direction to the first arm (as e.g. In the letter “N”) . The first arm 106 and second arm 108 point in the same direction.

The U-shaped body comprises (such as but not limited to upon each of the first arm 106 and the second arm 108) one or more fingers 110 which may, as appropriate, reach into an interior of the substantially U-shaped body 104 forming barb-like structures. This allows the clip 102 to grasp a further item within the interior of U-shaped body 104.

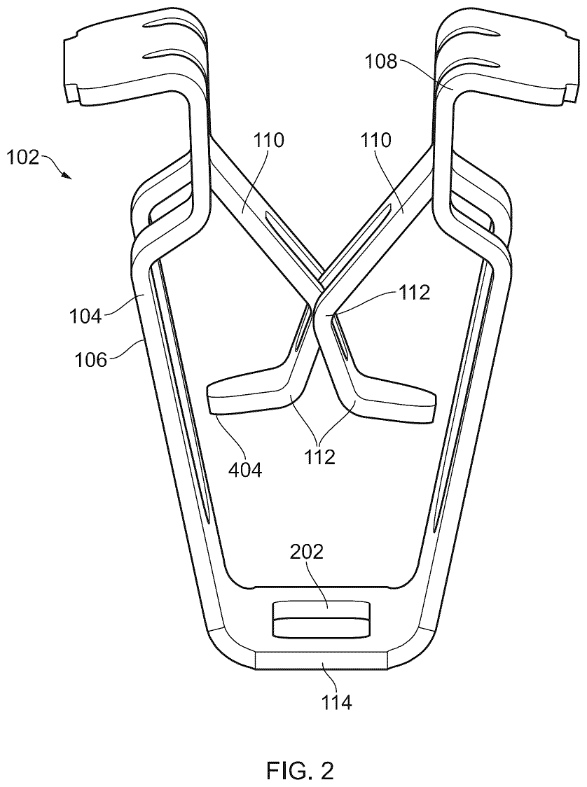

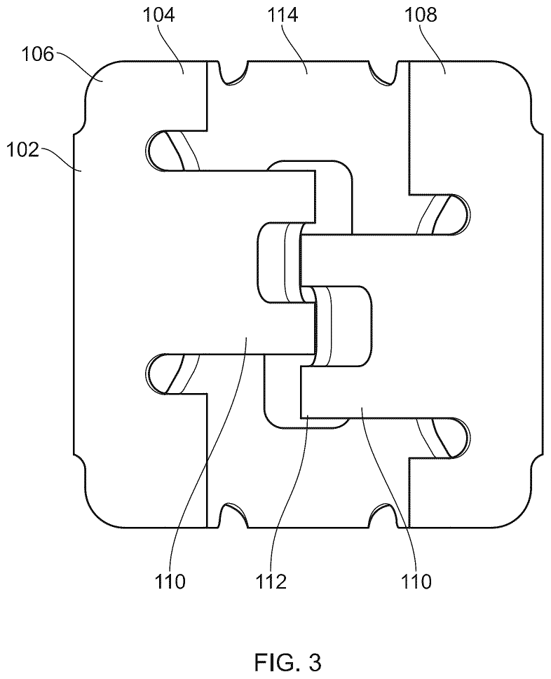

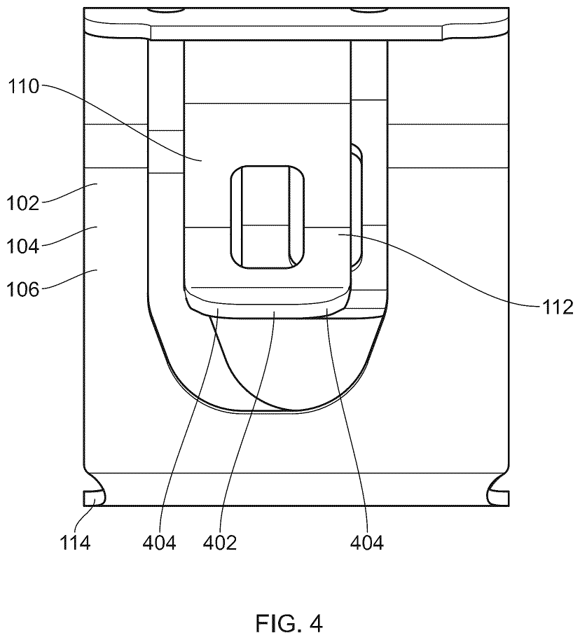

The one or more fingers 110 of the first arm 106 and the one or more fingers 110 of the second arm 108 interweave with each other. Here interweave means there is no gap between the fingers 110 of the first arm and the fingers 110 of the second arm 108 when the clip is viewed such that the body presents a “U” shape to the viewer (i.e. A front view, per FIG. 2). A gap may be present between fingers 110 of the first arm and the fingers 110 of the second arm 108 when the clip is viewed at an angle perpendicular to the view where the body presents a “U” shape to the viewer (i.e. On the side, per FIG. 4). The arrangement can be viewed in the top view provided in FIG. 3 showing the fingers 110 interwoven with each other. The fingers 110 are shown with an alternating weave, however it will be apparent that other weaves will be acceptable such as two fingers of the first arm 106 surrounded by the two fingers 110 of the second arm 108 or even a random arrangement provided an overlap is present.

When located upon the arms, each of the first and second arm 108 may respectively comprise two or more fingers 110. Optionally, the two or more fingers are linked via a bridge 402 to ensure effective attachment of the fingers 110 to a load and ensure forces are spread over the plural fingers. Further optionally the bridge links the two or more fingers between finger tips 404 of the two or more fingers.

The one or more fingers 110 may comprise at least one knuckle 112 which provided a defined inflexion point in each finger. Optionally, or alternatively, at least one of the one or more fingers is curved (either along the whole fingers 110 length or at an inflexion point provided by a knuckle 112) such that a finger tips 404 of the at least one of the one or more fingers 110 points towards the arm that finger is attached to.

The one or more fingers may each comprise at least one knuckle 112, wherein the one or more fingers interweave (i.e. Overlap at that point) with each other about at least one knuckle 112.

The clip may be formed by stamping, optionally in a single process and/or from metal. Optionally or alternatively, the substantially U-shaped body comprises at least one aperture, and further optionally wherein the at least one aperture is located on a base of the body.

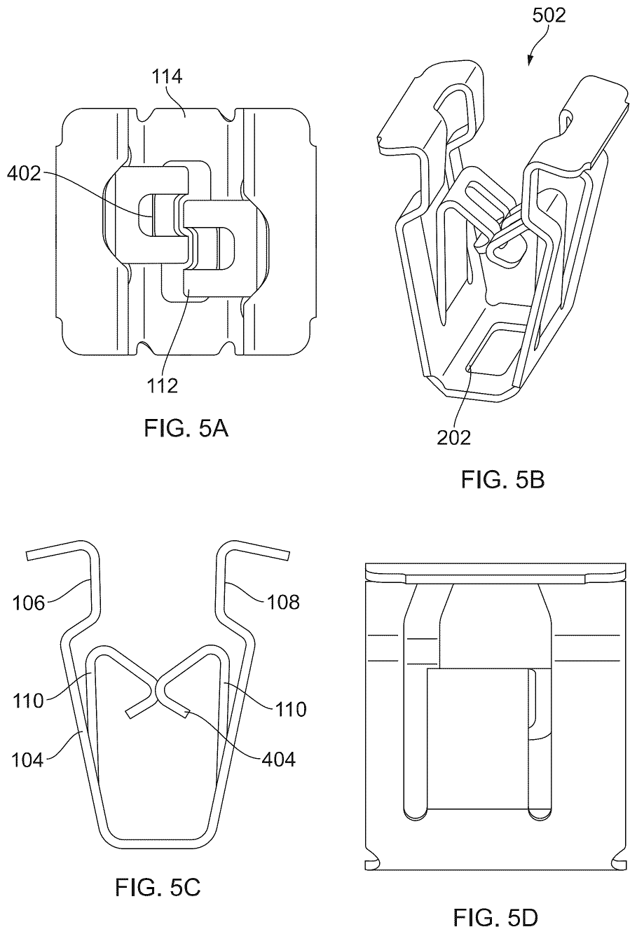

FIGS. 5A through 5D show an alternative clip 502 which shares many similar attributes to the other clips as described herein. Like features are provided with like reference numerals, so as to avoid unnecessary repetition. Clip 502 differs from clip 102 in that the fingers depend from an end of the arms that are proximal to the base. Indeed, the finger may extend directly from the base. The fingers initially extend towards the open end of the U-shaped body but then point towards an interior via bends at the knuckles 112. There are two knuckles 112 per finger in this variation, however, different numbers of knuckles are possible as described elsewhere. The knuckles 112 bend in the same direction (both clockwise in a direction running from the base of the finger towards the tip when viewed from a particular single side) in this variation, although different configurations are possible. This arrangement causes the finger to initially bend away from the arms via a first knuckle 112, but then the fingers return to pointing towards the arms via the second knuckle.

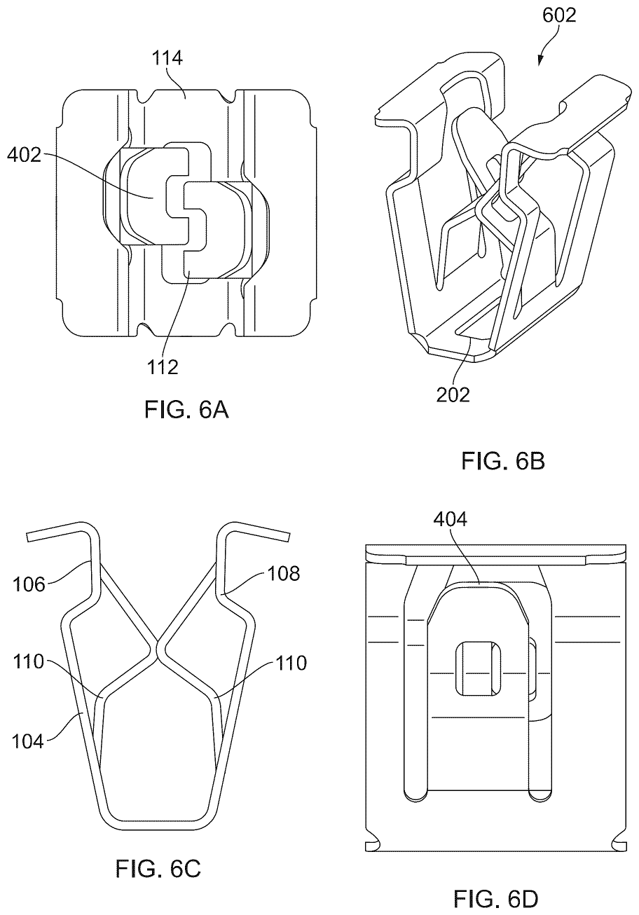

FIGS. 6A through 6D show an alternative clip 602 which shares many similar attributes to the other clips as described herein. Like features are provided with like reference numerals, so as to avoid unnecessary repetition. Clip 602 differs from clip 102 in that the fingers depend from an end of the arms that is proximal to the base. Indeed, the finger may extend directly from the base. The fingers initially extend towards the open end of the U-shaped body, but then point towards the respective arms to which the fingers are attached, or their nearest arm, where the finger is attached directly to the base. There are two knuckles 112 per finger in this variation, however, different numbers of knuckles are possible as described elsewhere. The knuckles 112 bend in opposing directions in this variation (one clockwise, and one anticlockwise, in a direction running from the base of the finger towards the tip when viewed from a particular single side), although different configurations are possible. This arrangement causes the finger to initially bend away from the arms via a first knuckle 112, but then the fingers return to pointing towards the arms via the second knuckle.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A clip (102), suitable for attaching a panel to a substrate, the clip comprising:
a substantially U-shaped body (104) comprising a first arm (106) and a second arm (108),
wherein the first arm and the second arm are in opposition with one another; and
two or more fingers (110) attached to the substantially U-shaped body,
wherein the two or more fingers interweave with each other.

2. The clip of claim 1 wherein two or more of the fingers are linked via a bridge (402), and optionally wherein the bridge links the two or more fingers between finger tips (404) of the two or more fingers.

3. The clip of claim 1, wherein the fingers comprise at least one knuckle (112).

4. The clip of claim 3, wherein the two or more fingers interweave with each other about the at least one knuckle.

5. The clip of claim 1, wherein at least one of the two or more fingers is curved such that a finger tip of the at least one finger, points towards either the first arm or the second arm.

6. The clip of claim 1, wherein the clip is a stamped-metal clip.

7. The clip of claim 1, wherein the substantially U-shaped body comprises at least one aperture (202), and further optionally wherein the at least one aperture is located on a base (114) of the U-shaped body (104).

8. The clip of claim 1, wherein one or more of the fingers are attached to the first arm or the second arm.

9. The clip of claim 1, wherein the first arm and the second arm each comprise one or more of the fingers.

10. The clip of claim 9, wherein the one or more fingers reach into an interior of the substantially U-shaped body.
